(19) United States
(12) Patent Application Publication
(10) Pub. No.: US 2013/0172794 A1
(43) Pub. Date: Jul. 4, 2013

(54) PALM MASSAGE DEVICE

(71) Applicant: Chih-Hua Tao, Kaohsiung (TW)

(72) Inventor: Chih-Hua Tao, Kaohsiung (TW)

(73) Assignee: CHE TAI INTERNATIONAL CO., LTD., Kaohsiung (TW)

(21) Appl. No.: 13/342,972

(22) Filed: Jan. 4, 2012

(51) Int. Cl. A61H 15/00

(52) U.S. Cl. 601/122

(57) ABSTRACT

A palm massaging device includes a palm-shaped equipment having a thumb portion, a finger portion, and a palm portion. The thumb portion, the finger portion, and the palm portion form a massaging area. Massaging elements are set on terminal ends of the thumb portion and the finger portions, and are also set on the palm portion. Therefore, one massaging element is set on the terminal of the thumb portion, more massaging elements are set on the terminal ends of the finger portions, and one massage element, at least, is set on the contact between the palm portion, the thumb portion, and the finger portion.

### BACKGROUND OF THE INVENTION

1. Field of the Invention

This invention concerns a massaging device, and in particular, relates to such a device for the palm.

2. Description of Related Art

As shown in FIG. 1, generally speaking, the tips of the fingers of a person's palms often have poor blood circulation; therefore, a palm massage machine exists for older people or those with low metabolism who are prone to symptoms related to poor blood circulation conditions. Typically, and in fact, a proper massage can improve blood circulation and other symptoms but the effectiveness of these methods can be improved.

There are no massage products related to the fitness of the peripheral nerves of the limbs on the market. Therefore, for a general user to obtain an effective nerve massage of the peripheral limbs, there are certain difficulties to overcome. To resolve this issue, it is necessary to design an appropriate device to facilitate improvements in the related symptoms of users.

### SUMMARY OF THE INVENTION

A palm massaging device comprises a palm-shaped device. The palm-shaped device comprises an end of thumb portion, an end of fingers portion and a palm portion. The end of the thumb portion and the end of the fingers portion are coupled together, forming a glove shape, and the thumb portion, the fingers portion and the palm portion form a massaging area.

Massaging elements are set at the end of the thumb portion, the end of the fingers portion, and the palm portion.

The end of thumb massage element and the end of the fingers portions are configured with many massaging elements, and the connections with the palm portion, the thumb portion and the fingers portion are configured as a massage element.

### BRIEF DESCRIPTION OF THE DRAWINGS

FIG. 1 is a diagram of the end of a palm.

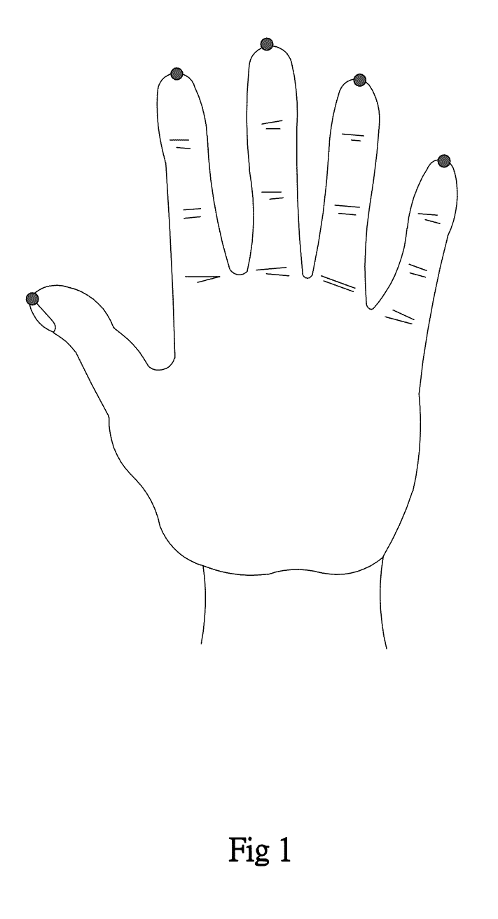

FIG. 2 is a diagram of a first preferred embodiment of the invention.

FIG. 3 is a diagram of a cross-section of an inflatable airbag of an embodiment massage device of the invention;

FIG. 4 shows an internal motor of a roller massage device of an embodiment of the invention;

FIG. 5 is a side view of a roller massage of an internal drive motor of a massage device of an embodiment of the invention;

FIG. 6 shows a link of a roller massage device and external motor drive components of an embodiment massage device;

FIG. 7 shows a link of a roller massage device and external motor drive components of an embodiment massage device; and

FIG. 8 is a cross-sectional view of an insulation layer of an embodiment of the invention.

### DETAILED DESCRIPTION OF THE INVENTION

The patent features and technical content related to this invention will be clearly shown in the detailed descriptions as follows that refer to three preferred embodiments of the invention.

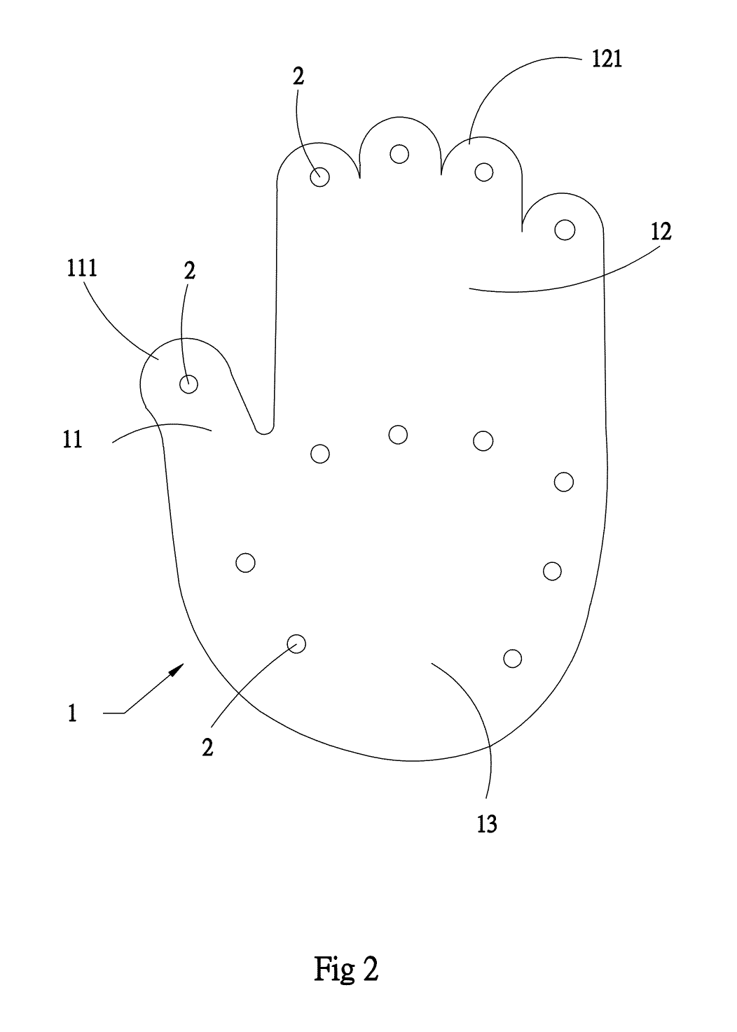

As shown in FIG. 2, a first preferred embodiment of the invention comprises a palm-shaped device 1 and a plurality of massaging elements 2.

The palm-shaped device 1 is made of a soft material having a sleeve-like structure for wrapping a user's palm. The palm-shaped device 1 includes a thumb portion 11, a fingers portion 12, a palm portion 13, and an isolation layer 10. Also, the thumb portion 11 and the fingers portion 12 are connected with the palm portion 13 respectively to form a glove shape. Therefore, the thumb portion 11, the fingers portion 12 and the palm portion 13 together form a massaging area, and the isolation layer 10 is used for insulating the user's palm from the palm portion 13. Preferably, when the user utilizes the palm-shaped device 1, the user's thumb is inserted into the massaging space of the thumb portion 11. The rest of the user's fingers can be inserted into the massaging space of the fingers portion 12 and the user's palm can be inserted into the massaging space of the palm portion 13.

Massaging elements 2 are evenly distributed in the thumb portion 11, the fingers portion 12 and the palm portion 13. An end 111 of the thumb portion 11 is provided with a massaging element 2. All ends 121 of the fingers portion 12 are provided with four massaging elements 2. The end 111 of the thumb portion 11 and the ends 121 of the fingers portion 12 are respectively connected to a terminal distal from the other terminals of the palm portion 13. The palm potion 13 is provided with at least one massaging element 2.

Preferably, there are massaging elements 2 disposed on the palm portion 13, and the massaging elements 2 are arranged peripherally and adjacent to the connections between the palm portion 13, the thumb portion 11 and the fingers portion 12.

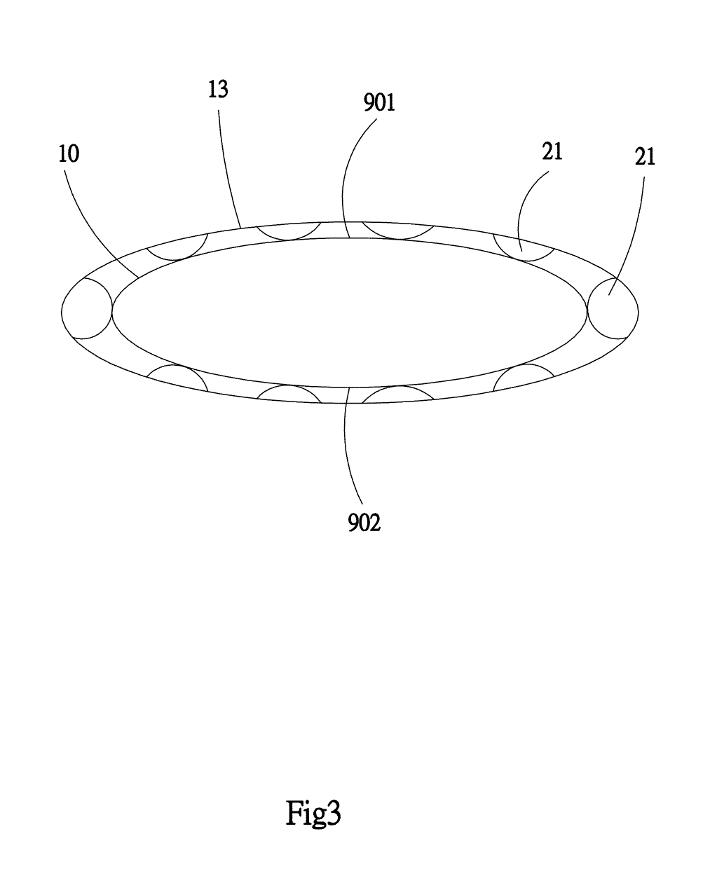

With reference to FIG. 3, in this preferred embodiment, after the user's palm is inserted into the palm-shaped equipment 1, the isolation layer 10 contacts the back side of the user's palm with a first surface 901, and the isolation layer 10 contacts the user's palm with a second surface 902. In this preferred embodiment, each massaging element 2 is an inflatable airbag 21 located on the first surface 901 or the second surface 902. When the user's palm is placed in the massaging space and each airbag 21 is inflated, the inflated airbags 21 create massaging pressure to the corresponding positions on the palm. After a predetermined period of time, every airbag 21 is deflated, and the messaging pressure is released. Therefore, with various repeated inflation/deflation combinations of the airbags 21, different massaging effects can be generated for the user's palm.

Preferably, there are more protruding particles on each inflatable airbag 21 located on the second surface 902. Accordingly, these protruding particles can increase the massage effect, and comfort for the user.

Furthermore, there are various inflation methods for the airbags 21; for example, the airbags 21 located on the first surface 901 are inflated and the airbags 21 located on the second surface 902 are deflated at the same time. When the airbags 21 located on the first surface 901 are inflated to saturation, the airbags 21 located on the second surface 902 are completely deflated. When the airbags 21 located on the first surface 901 start to deflate and the airbags 21 located on the second surface 902 start to inflate at the same time. The motions repeat in this cycle to simulate the action of palm kneading which increases the massaging effect.

In addition, in this preferred embodiment, the airbags 21 located on the second surface 902 can be detachable from the palm-shaped equipment 1 for replacement.

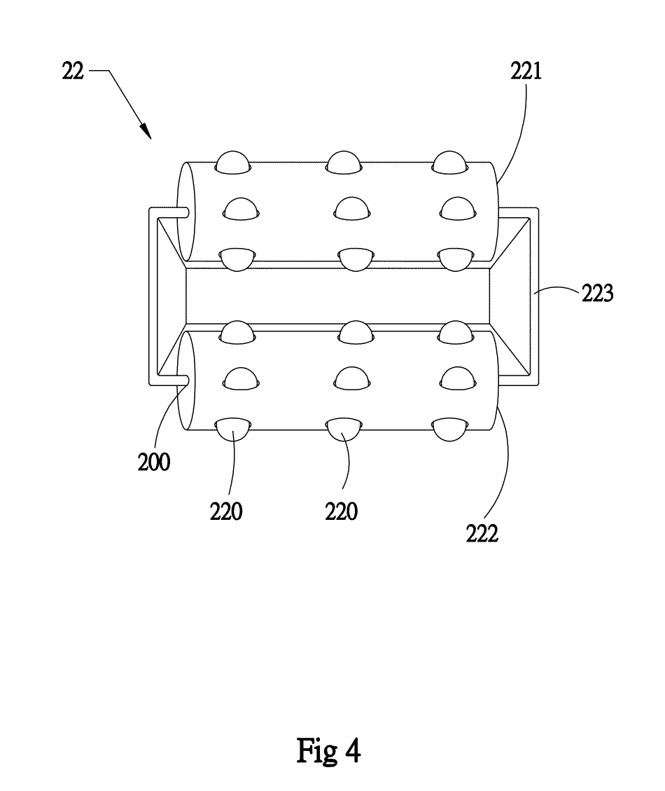

Between a second preferred embodiment of this invention and the first preferred embodiment, a difference is as follows. Please refer to FIG. 4; each massaging element 2 located on the second surface 902 is a massaging roller 22. The massaging roller 22 includes a first roller 221, a second roller 222, and a bracket 223 connected to the first roller 221 and the second roller 222. Both surfaces of the first roller 221 and the second roller 222 have a plurality of protruding particles 220. Therefore, when the massaging roller 22 is disposed between the second surface 902 and an isolation layer 10 parallel with the palm, the first roller 221 and the second roller 222 roll between the second surface 902 and the isolation layer 10. When the user's palm is placed at the massaging area, the massage results are apparent.

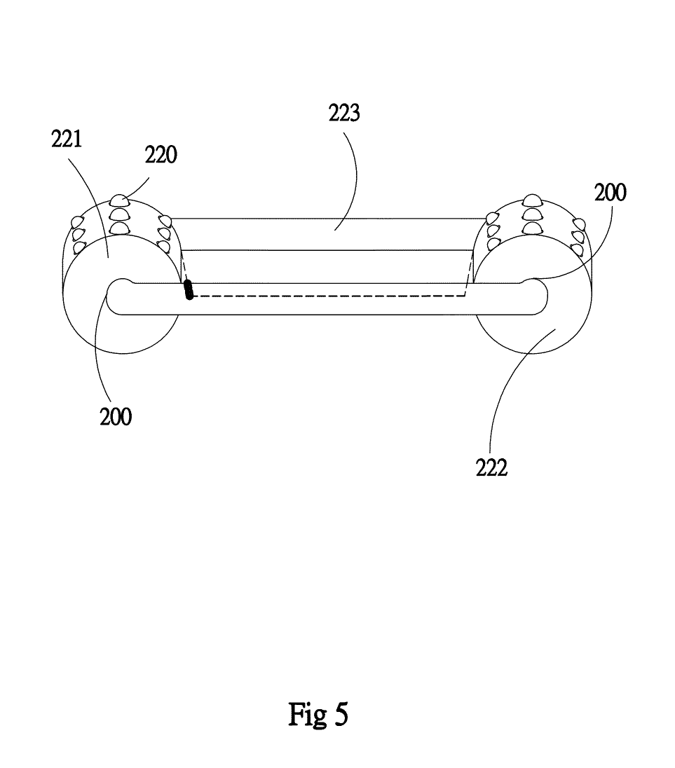

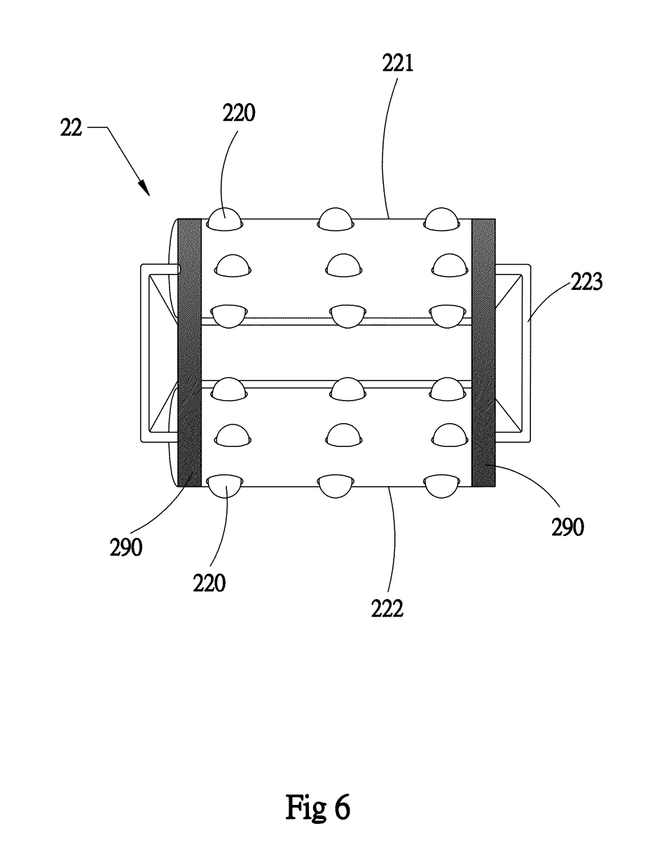

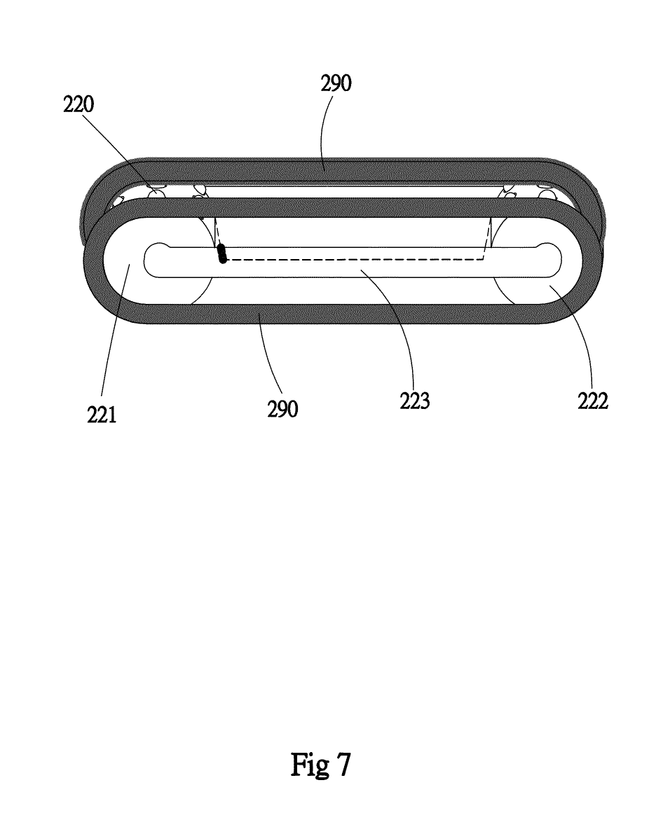

Please refer to at FIGS. 4 and 5 together; the first roller 221 and the second roller 222 have an internal motor 200 respectively. Or, as shown in FIGS. 6 and 7, a linkage element 290 (such as a tracking belt) connects the first roller 221 and the second roller 222 together. The linkage components 290 drive the first roller 221 and the second roller 222 by connecting to an external motor (not shown). Preferably, each protruding particle 220 is a small steel ball and disposed on the surface of the first roller 221 and the second roller 222, and each protruding particle 220 is slidable within a small range.

In addition, in this preferred embodiment example, the massaging roller 22 is detachable from the palm-shaped device for replacement.

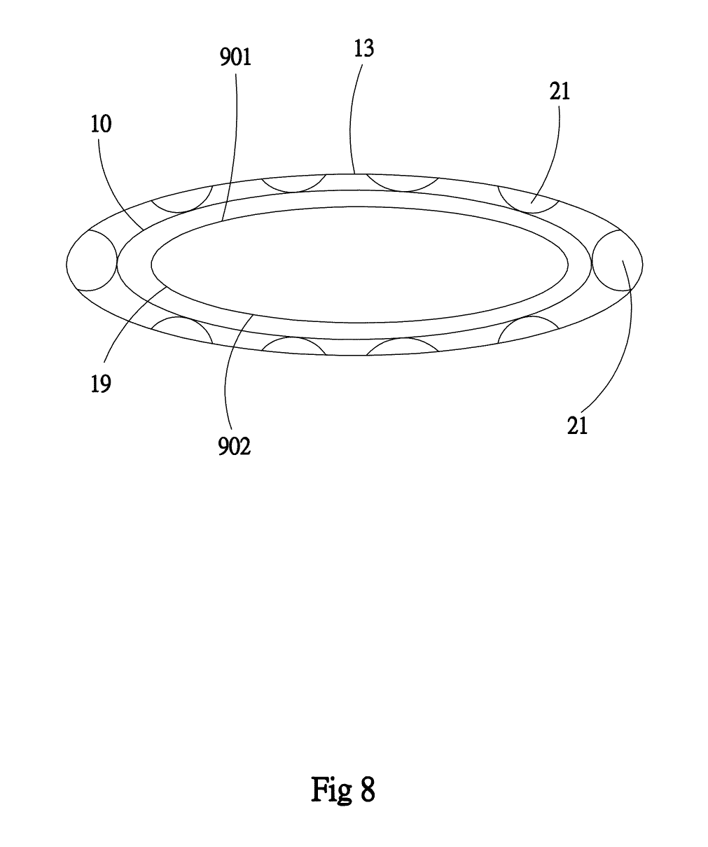

Between a second preferred embodiment of this invention and the first preferred embodiment, a difference is as follows. Please refer to FIG. 8. The third preferred embodiment further comprises a heat insulation layer 19 between the massaging space and the isolation layer 10. For example, when the airbags 21 are inflated, they can also be heated between the heat insulation layer 19 and the isolation layer 10. Therefore, the user's palms are massaged and kept at a steady temperature at the same time to increase comfort.

Preferably, the insulation layer 19 is made of a thin and light material, so heat can be passed appropriately to the user's palm, and will not affect the massaging effect. In other words, the protruding particles 220 on the airbag 21 or the first roller 221 and the second roller 222 are still efficient to provide a massaging effect.

As above, the present invention can perform various types of massaging of the end user's palm, but can also be heated in order to increase the comfort of the massage. Therefore, the ultimate purpose of the present invention can be achieved.

While the invention has been described in terms of preferred embodiments, those skilled in this field will recognize that the invention can be operated with modifications within the spirit and scope of the appended claims.

What is claimed is:

1. A palm massaging device, comprising:
a palm-shaped equipment comprising:
an end of thumb part;
an end of fingers part; and
a palm part; wherein the end of the thumb portion and the end of the fingers portion are coupled together to form a glove shape, and the thumb portion, the fingers portion and the palm portion form a massaging area, and massaging elements are set at the end of the thumb portion, the ends of each fingers portion, and in the palm portion;
wherein the end of the thumb massage element and the end of the fingers portion are configured with massaging elements and connections with the palm portion, the thumb portion and the fingers portion are configured as a massage element.

2. The palm massaging device of claim 1, wherein a massage element located on the palm portion is a massage roller, the massage roller comprising a first roller, a second roller and a bracket linked to the first roller and the second roller.

3. The palm massaging device of claim 2, wherein the first roller and the second roller are driven by an internal motor to cause the first roller and the second roller to scroll.

4. The palm massaging device of claim 2, wherein the massage roller further comprises a link element to link the first roller and the second roller.

5. The palm massaging device of claim 2, wherein an isolation layer is disposed between the massage element and the massaging area.

6. The palm massaging device of claim 5, wherein an insulation layer is disposed between the isolation layer and the massaging area.

7. The palm massaging device of claim 1, wherein each massage element is an airbag and each airbag is inflatable.

8. The palm massaging device of claim 7, wherein an isolation layer is between the massage element and the massaging area.

9. The palm massaging device of claim 8, wherein an insulation layer is between the isolation layer and the massaging area.

10. The palm massaging device of claim 1, wherein massaging elements disposed on the palm-shaped equipment are detachable.
